(19) United States
(12) Patent Application Publication
(10) Pub. No.: US 2002/0131524 A1
(43) Pub. Date: Sep. 19, 2002

(54) System and method using multi-dimensional constellations with low receiver soft- decision extraction requirements

(76) Inventors: Victor Demjanenko, Pendleton, NY (US); Frederic J. Hirzel, Clinton Township, MI (US); Juan Alberto Torres, Orchard Park, NY (US)

Correspondence Address: Ronald Coslick, FOLEY & LARDNER, Suite 3500, 2029 Century Park East, Los Angeles, CA, 90067-3021, US

(21) Appl. No.: 09/991,372

(22) Filed: Nov. 13, 2001

Related U.S. Application Data
(60) Provisional application No. 60/248,099, filed on Nov. 13, 2000.

(51) Int. Cl. H04L 27/36; H04L 23/02; H04L 5/12

(52) U.S. Cl. 375/298; 375/261

(57) ABSTRACT

A non-separable symbol constellation may comprise constituent constellations having separable I and Q. Such a non-separable constellation may be decoded with the efficiency of a separable constellation by decoding for each of the constituent constellations individually. In a transmitter, transmit data may be mapped to symbols by selecting a constituent constellation and I and Q values for a symbol to be transmitted. In a receiver, decoders may decode for each constituent individually.

### CONTINUATION DATA

This non-provisional patent application claims the benefit under 35 U.S.C. Section 119(e) of U.S. Provisional Patent Application Serial No. 60/248,099, filed on Nov. 13, 2000, incorporated herein by reference.

### FIELD OF THE INVENTION

Through use of forward error encoders (Turbo codes, Low Density Parity Check, Repeat-Accumulate codes, etc) and soft-decision decoders, transmission over AWGN channels has achieved performance very close to the theoretical Shannon limit. Important in the construction of the encoder/decoder system is the extraction of accurate soft-decision information from the channel as an input into the receiver's decoder.

The normal technique for extracting soft-decision information from the channel is to create a value representing the probability of the received symbol as a function of every possible transmit symbol. When anti-podal signaling is used, this require very little processing. For multi-dimensional transmit constellations, the amount of processing becomes problematic.

The solution normally employed for high order QAM constellations is to map independently the I and Q dimension and use simple square constellations where the amount of processing per bit increases as the square root of the size of the constellation. Unfortunately, square constellations limit the number of constellation choices needed for robust communications of arbitrary noise level channels.

This method describes a technique of creating arbitrary constellations whose soft-decision extraction complexity is comparable to that of a square constellation. While only two-dimensional constellations are shown, these techniques may be extended to multi-dimensional constellations.

### BACKGROUND OF THE INVENTION

The conventional technique for extracting soft-decision information from the channel is to create a value representing the probability of the received symbol being a one as:

$$\frac{\sum of the measures with the transmit symbol was 0}{\sum of the measures with the transmit symbol was 1} \qquad ( 1 )$$

where the measure is defined as:

$${ⅇ}^{( - {n}^{*} metric )} ; n = \frac{1}{No} , \frac{1}{2 No} \qquad ( 2 )$$

and where:

metric=Euclidian distance (or square of the Euclidian distance) from the possible transmit symbol to the received symbol.

For example, for the 16 point constellation:

$$\begin{matrix}( - 3 , + 3 ) & ( - 1 , + 3 ) & ( + 1 , + 3 ) & ( + 3 , + 3 ) \\ ( - 3 , + 1 ) & ( - 1 , + 1 ) & ( + 1 , + 1 ) & ( + 3 , + 1 ) \\ ( - 3 , - 1 ) & ( - 1 , - 1 ) & ( + 1 , - 1 ) & ( + 3 , - 1 ) \\ ( - 3 , - 3 ) & ( - 1 , - 3 ) & ( + 1 , - 3 ) & ( + 3 , - 3 )\end{matrix}$$

with the symbols assignments of:

$$\begin{matrix}0000 & 0001 & 0011 & 0010 \\ 0100 & 0101 & 0111 & 0110 \\ 1100 & 1101 & 1111 & 1110 \\ 1000 & 1001 & 1011 & 1010\end{matrix}$$

using a two-digit representation:

$$\begin{matrix}I & \{ 0 & \{ 0 & \{ 1 & \{ 1 & \\ & 0 \} & 1 \} & 1 \} & 0 \} & \\ & & & & & Q \\ & 00 & 01 & 03 & 02 & ( 00 ) \\ & 10 & 11 & 13 & 12 & ( 01 ) \\ & 30 & 31 & 33 & 32 & ( 11 ) \\ & 20 & 21 & 23 & 22 & ( 10 )\end{matrix}$$

and the point assignments of:

$$\begin{matrix}p30 & p31 & p32 & p33 \\ p20 & p21 & p22 & P23 \\ p10 & p11 & p12 & p13 \\ p00 & p01 & p02 & p03\end{matrix}$$

p_{i,j}=(x_{i,j},y_{i,j}) (3)

In order to extract the probability of the least significant bit for received value q=(u,v), the transmit points are separated into those points whose least significant bit is 1 and those points whose least significant bit is 0 as:

$$\begin{matrix}bit == 1 & m31 , m21 , m11 , m01 \\ & m32 , m22 , m12 , m02 \\ bit == 0 & m30 , m20 , m10 , m00 \\ & m33 , m23 , m13 , m03\end{matrix}$$

and the metrics mij are:

m_{i,j}=∥p_{i,j}−q∥²=(x_{i,j}−u)²+(y_{i,j}−v)² (4)

and the metrics in respect to the least significant bit are:

$$value = \frac{S1}{S0} = \frac{{\sum }_{bit = 1} {ⅇ}^{( - {n}^{*} {m}_{ij} )}}{{\sum }_{bit = 0} {ⅇ}^{( - {n}^{*} {m}_{ij} )}} \begin{matrix}ij = 31 , 21 , 11 , 01 , 32 , 22 , 12 , 02 \\ ij = 30 , 20 , 10 , 00 , 33 , 23 , 13 , 03\end{matrix} \qquad ( 5 )$$

The sum of the measures in respect to the least significant bit and the value extracted from the channel is:

$$S1 = {\sum }_{bit = 1} {ⅇ}^{( - {n}^{*} {m}_{ij} )} ij = 31 , 21 , 11 , 01 , 32 , 22 , 12 , 02 \qquad ( 6 )$$

For this example, there are 16 possible transmit symbols and there are also 16 calculation needed for creating the value extracted from the channel.

The foregoing example was selected to illustrate a constellation constructed and bits assigned such that the soft-decision information extraction has reduced complexity due to both the constellation's shape and the independent dimension assignments of the bits of the constellation's symbols.

For S1, the summation of the measures to each transmit symbol whose bit is 1 is given as:

$$\begin{matrix}S1 = {\sum }_{bit = 1} {e}^{( - {n}^{*} {m}_{ij} )} & ij = 31 , 21 , 11 , 01 , 32 , 22 , 12 , 02\end{matrix} \qquad ( 6 )$$

This summation can be separated into two summations, each for a “column” of possible constellations values as:

S1=S11+S12 (7)

where:

$$\begin{matrix}S 11 = {\sum }_{bit = 1} {ⅇ}^{( - {n}^{*} {m}_{ij} )} ij = 31 , 21 , 11 , 01 & ( 6 ) \\ S 12 = {\sum }_{bit = 1} {ⅇ}^{( - {n}^{*} {m}_{ij} )} ij = 32 , 22 , 12 , 02 & ( 9 )\end{matrix}$$

since mij is defined as:

mᵢⱼ=(xᵢⱼ−u)²+(yᵢⱼ−v)²=mxᵢⱼ+myᵢⱼ (10)

where:

mxᵢⱼ=(xᵢⱼ−u)² (11)

myᵢⱼ=(yᵢⱼ−v)² (12)

and using the property,

u^{(x+y)}=u^{x}u^{y} (13)

it is easily shown the S11, S12 are, for this constellation and bit assignment, accepting the notations:

mxⱼ=(column j−u)² (14)

myᵢ=(row i−v)² (15)

S11=Sye^{(-n*mx}^{ⱼ}⁾ j=1 choose any value for i (16)

S12=Sye^{(-n*mx}^{ⱼ}⁾ j=2 choose any value for i (17)

Sy=Σe^{(-n*my}^{ᵢ}⁾ i=0, 1, 2, 3 choose any value for j (18)

and thus, S1 can be defined as:

S1=SySx1; Sx1=Σe^{(-n*mx}^{ⱼ}⁾ j=1, 2 (19)

and similarly, S0 can be defined as:

S0=SySx0; Sx0=e^{(-n*mx}^{ⱼ}⁾ j =0, 3 (20)

and the ratio S1/S0 becomes:

$$value = \frac{S 1}{S 0} = \frac{Sy Sx 1}{Sy Sx 0} \qquad ( 21 )$$

$$value = \frac{Sx 1}{Sx 0} = \frac{\sum {ⅇ}^{( - {n}_{{mx}_{j}} )}}{\sum {ⅇ}^{( - {n}_{{mx}_{j}} )}} \begin{matrix}; j = 1 , 2 \\ ; j = 0 , 3\end{matrix} \qquad ( 22 )$$

which requires only 4 calculations instead of 16 calculations.

Of course, the same reduction of calculations will occur for all bits.

This technique for reducing the processing complexity is frequently described as creating a constellation with separable or independently mapped I and Q dimensions.

When a communication system uses QAM constellations, if the I and Q dimensions are mapped independently, it is possible to considerably reduce the amount of processing required for decoding. The most straightforward way to use independent I and Q dimension is to use a simple square constellations, whereby the amount of processing per bit increases as the square root of the size of the constellation. Unfortunately, square constellations limit the number of constellation choices available, and a wide range of constellations is needed for robust communications in arbitrary noise level channels.

We hereby incorporate by reference the following references as describing additional background information:

1. Juan Alberto Torres, Frederic Hirzel and Victor Demjanenko, “Forward Error Correcting System With Encoders Configured in Parallel and/or Series”, International Patent Application Serial No. PCT/US99/17369 filed on Jul. 30, 1999.

2. Victor Demjanenko, Frederic Hirzel and Juan Alberto Torres, “Turbo Codes for QAM modulation Systems using independent I and Q Decoding techniques. Application to xDSL modems”, U.S. Provisional Patent Application No. 60/200,369 filed on Apr. 28, 2000.

### SUMMARY OF THE INVENTION

In accordance with embodiments of the invention, non-separable I and Q constellations may be comprised of constituent constellations having separable I and Q. In accordance with embodiments of the invention, non-separable I and Q constellations may be comprised of constituent constellations having separable I and Q. Data may therefore be encoded using such non-separable I and Q constellations by mapping the data to individual constituent separable I and Q constellations. Further, such data may be decoded by decoding for the constituent constellations individually, thus taking advantage of the processing gains of separable I and Q constellations while also enabling the use of a wide variety of non-square, non-separable I and Q constellations.

Thus, in accordance with one embodiment of the invention, a transmitter may map a data stream to symbols of a symbol constellation to produce a symbol stream, modulate a signal in accordance with the symbol stream, and transmit the modulated signal. The symbol constellation may comprise a plurality of constituent constellations each having independent I and Q mapping. Mapping of the data stream to symbols of the symbol constellation may comprises selecting one of the constituent constellations and selecting an I value of a symbol in the selected constituent constellation and a Q value of a symbol in the selected constituent constellation in accordance with the data stream. Related embodiments may pertain to a transmitter performing such processing.

In accordance with further embodiments of the invention, a receiver may receive a modulated signal representing a symbol stream that is generated by mapping a transmit data stream to symbols of a symbol constellation, demodulate the signal, and generate a received data stream from the demodulated signal. The symbol constellation may comprise a plurality of constituent constellations that each have independent I and Q mapping. The receiver may generate the received data stream by applying the demodulated signal to a plurality of decoders, each of which provides decoding with respect to one of the constituent constellations, and determining symbols of the symbol stream from outputs of the decoders. Related embodiments may pertain to a receiver performing such processing.

### BRIEF DESCRIPTION OF THE DRAWINGS

FIG. 1 shows a 16 QAM constellation with Gray Mapping.

FIG. 2 shows a non-square, non-separable I and Q subset of the constellation of FIG. 1.

FIG. 3 shows the 8 QAM case 1.

FIG. 4 shows the subset constellation of 8 QAM case 1.

FIG. 5 shows the 8 QAM case 2.

FIG. 6 shows the subset constellation of 8 QAM case 2.

FIG. 7 shows the 8 QAM case 3

FIG. 8 shows the subset constellation of 8 QAM case 3.

FIG. 9 shows the 8 QAM case 4.

FIG. 10 shows the subset constellation of 8 QAM case 4.

FIG. 11 shows the 64 QAM constellation with Gray Mapping.

FIG. 12 shows a non-square, non-separable I and Q subset of the constellation of FIG. 11.

FIG. 13 shows the 32 QAM case 1.

FIG. 14 shows the subset constellation of 32 QAM case 1.

FIG. 15 shows the 32 QAM case 2.

FIG. 16 shows the subset constellation of 32 QAM case 2.

FIG. 17 shows the 32 QAM case 3.

FIG. 18 shows the subset constellation of 32 QAM case 3.

FIG. 19 shows the 32 QAM case 4.

FIG. 20 shows the subset constellation of 32 QAM case 4.

FIG. 21 shows the 32 QAM case 5.

FIG. 22 shows the subset constellation of 32 QAM case 5.

FIG. 23 shows 32 QAM case 6.

FIG. 24 shows the subset constellation of 32 QAM case 5.

FIG. 25 shows the 256 QAM constellation with Gray Mapping.

FIG. 26 shows a non-square, non-separable I and Q subset of the constellation of FIG. 25.

FIG. 27 shows the 128 QAM case 1.

FIG. 28 shows the subset constellation of 128 QAM case 1.

FIG. 29 shows the 128 QAM case 2.

FIG. 30 shows the subset constellation of 128 QAM case 2.

FIG. 31 shows the 128 QAM case 3.

FIG. 32 shows the subset constellation of 128 QAM case 3.

FIG. 33 shows the 128 QAM case 4.

FIG. 34 shows the subset constellation of 128 QAM case 4.

FIG. 35 shows the 128 QAM case 5.

FIG. 36 shows the subset constellation of 128 QAM case 5.

FIG. 37 shows the 128 QAM case 6.

FIG. 38 shows the subset constellation of 128 QAM case 6.

FIG. 39 shows the 128 QAM case 7.

FIG. 40 shows the subset constellation of 128 QAM case 7.

FIG. 41 shows the 128 QAM case 8.

FIG. 42 shows the subset constellation of 128 QAM case 8.

FIG. 43 shows mapping of a transmit data stream to I and Q values in a transmitter in accordance with a preferred embodiment of the invention.

FIG. 44 shows decoding of an input demodulated signal using separable I and Q constituent constellations in a receiver in accordance with a preferred embodiment of the invention.

### DETAILED DESCRIPTION OF PREFERRED EMBODIMENTS

Design of Constellations

In accordance with one embodiment of the invention, the performance of conventional non-square constellations may be improved by using non-square constellations that are comprised of constituent constellations having independent I and Q. The following describes one manner in which such a constellation may be designed.

First, begin with a square constellation that has double the number of points (2ⁿ⁺¹ points) in the desired non-square constellation to be constructed (2ⁿ points). For example, if a 32 QAM constellation is desired, begin with a constellation for 64 QAM with independent I and Q Gray mapping or Natural Mapping.

Next, delete every other point in each dimension such that every row retains half of its points and every column keeps half of its points and such that the remaining constellation points have the same distance between them.

Then, assign to each remaining point a number formed from the bits of the I value and bits of the Q value of the original constellation mapping, where one bit position of the I value or one bit position of the Q value have been removed. The first number is from the I dimension, called the 1-value, and the second number is from the Q dimension, called the Q-value.

When one bit in one dimension is removed, n-I bits of the n bit constellation-value have independent I and Q. They may be decoded in the same way as presented in provisional patent application serial No. 60/200,369.

In the general case that the symbol has n bits, if m bits are removed from one dimension, I or Q, the remaining bits have independent I and Q and they are decoded in the same way as presented in provisional patent application serial No. 60/200,369.

The resulting constellation is comprised of two constituent square constellations with independent I and Q. Data may be mapped to symbols of the two constituent constellations individually, and such symbols may be decoded by decoding the constituent constellations with independent probabilities. Examples of the application of this design method to various QAM cases is provided below.

Application to the 2 QAM case.

The 2 QAM case is a special case where the two resulting points can always decoded independently.

Application to the 8 QAM case.

The design of an 8 QAM constellation with independent I and Q using Gray mapping has 4 possible combinations or cases. In the following description, the first 2 steps are common all 4 cases. Steps 3 and 4 are unique for each case.

Step 1.

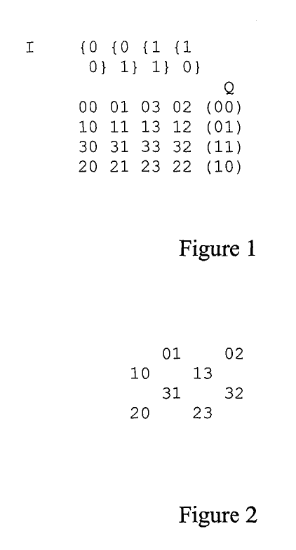

Draw a square constellation that has double the number of points (2ⁿ⁺¹ points) in the desired non-square constellation (2ⁿ points). For 8 QAM, n=3, the square constellation is 16 QAM with independent I&Q Gray mapping or Natural Mapping. FIG. 1 shows the 16 QAM constellation with Gray Mapping. The first number represent the Q dimension and the second number represents the I dimension.

Step 2.

Delete every other point in each dimension such that each row keeps half of its points and each column keeps half of its points, and such that the constellation points that remain have the same distance between them. FIG. 2 shows the constellation after removing half of the points. The technique produces similar constellations if the removed points are kept and the kept points are removed.

Step 3.

Assign to each remaining point a number formed from the bits of the I value and bits of the Q value of the original constellation map, where one bit position of the I value or one bit position of the Q value have been removed. There are four manners in which this may be done.

Case 3.1.

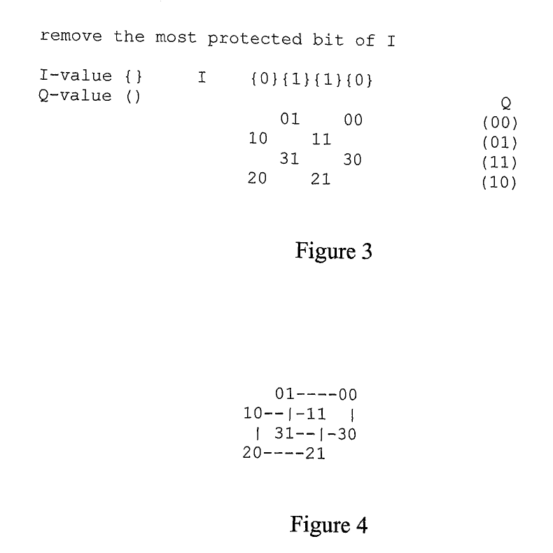

Remove the most protected bit in I. FIG. 3 shows the region created in this case. The resulting non-square constellation is the superposition of two square constituent constellations, with each constellation being offset from the other by one half spacing in the I and Q dimensions. This relationship will be described hereinafter as the constituents being shifted with respect to one another. The two constituents are shown in FIG. 4.

Case 3.2.

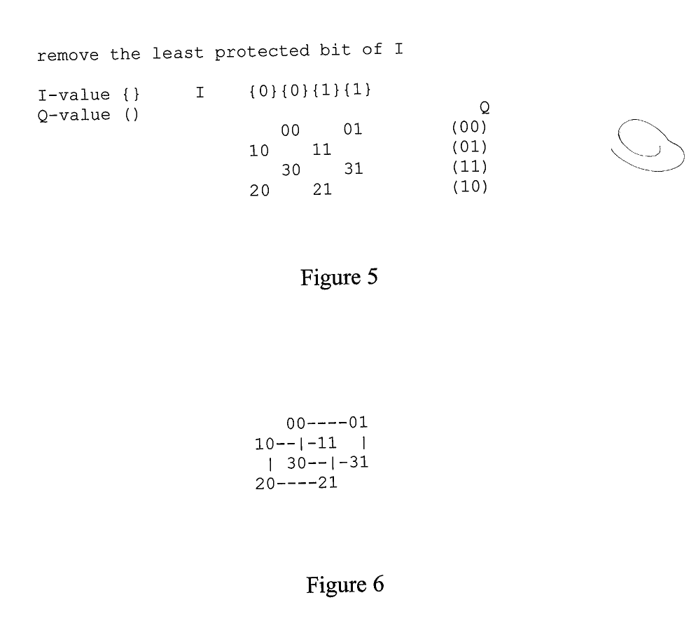

Remove the least protected bit in I. FIG. 5 shows the region created in this case. The resulting non-square constellation is the superposition of two square constituent constellations, one of which is shifted with respect to the other. This is shown in FIG. 6. In this case 2 it is important to note that the OX values of the two subset square constellations are the same 0 for the first column and 1 for the second column. This is very helpful to the decoding process, reducing considerably the computational requirements.

Case 3.3.

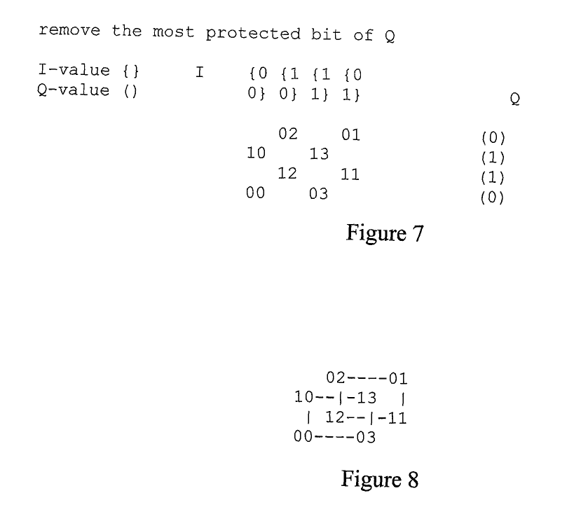

Remove the most protected bit Q. FIG. 7 shows the region created in this case. In this case the resulting non-square constellation is the superposition of two square constituent constellations, one of which is shifted with respect to the other. This is shown in FIG. 8.

Case 3.4.

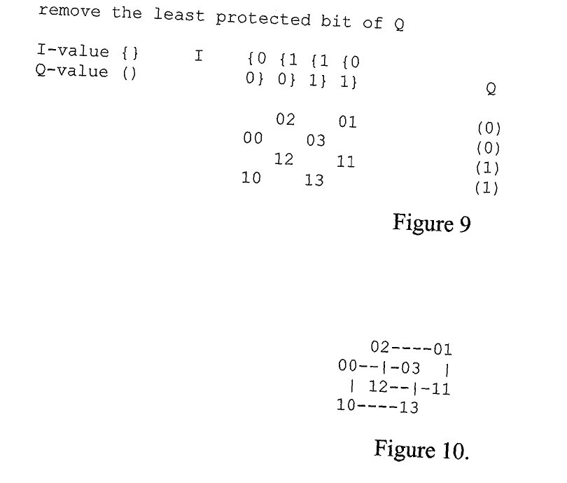

Remove the least protected bit Q. FIG. 9 shows the region created in this case. In this case it is noted that in the previous case the resulting non-square constellation is the superposition of two square constituent constellations, one of which is shifted with respect to the other. This is shown in FIG. 10.

In case 3.4 it is noted that the OY values of the two subset square constellations are the same 0 for the first row and 1 for the second row. This is very helpful to the decoding process, reducing considerably the computational requirements.

Application to the 32 QAM case.

The following description illustrates the 6 possible cases for a 32 QAM constellation with Gray mapping.

Step 1.

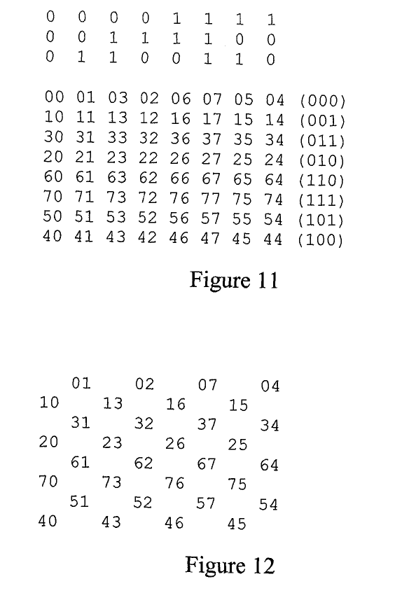

Draw a the square constellation that has double the number of points (2ⁿ⁺¹ points) in the desired non-square constellation (2ⁿ points). For 32 QAM, n=5, the square constellation is 64 QAM with independent I and Q Gray mapping or Natural Mapping. FIG. 11 shows the 64 QAM constellation with Gray Mapping. The first number represents the Q dimension and the second number represents the I dimension.

Step 2.

Delete every other point in each dimension such that each row keeps half of its points and every column keeps half of its points, and such that the constellation points that remains have the same distance between them. FIG. 12 shows the constellation after removing half of the points. The technique produces similar constellations if the removed points are kept and the kept points are removed.

Step 3.

Assign to each remaining point a number formed from the bits of the I value and bits of the Q value of the original constellation map, where one bit position of the I value or one bit position of the Q value has been removed. There are six manners in which this may be done.

Case 3.1.

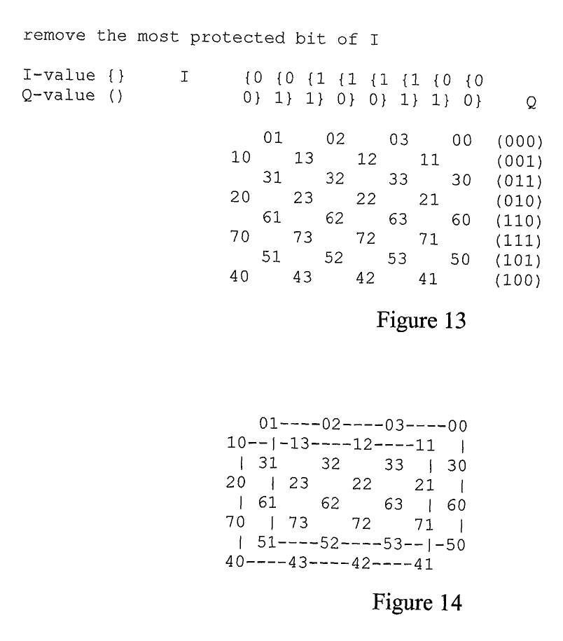

Remove the most protected bit in I. FIG. 13 shows the region created in this case. The resulting non-square constellation is the superposition of two square constituent constellations, one of which is shifted with respect to the other. This is shown in FIG. 14.

Case 3.2.

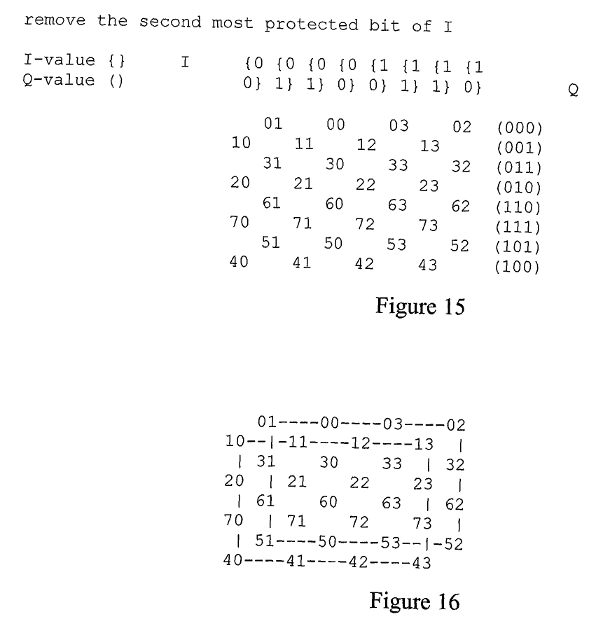

Remove the second most protected bit in I. FIG. 15 shows the region created in this case. The resulting non-square constellation is the superposition of two square constituent constellations, one of which is shifted with respect to the other. This is shown in FIG. 16.

Case 3.3.

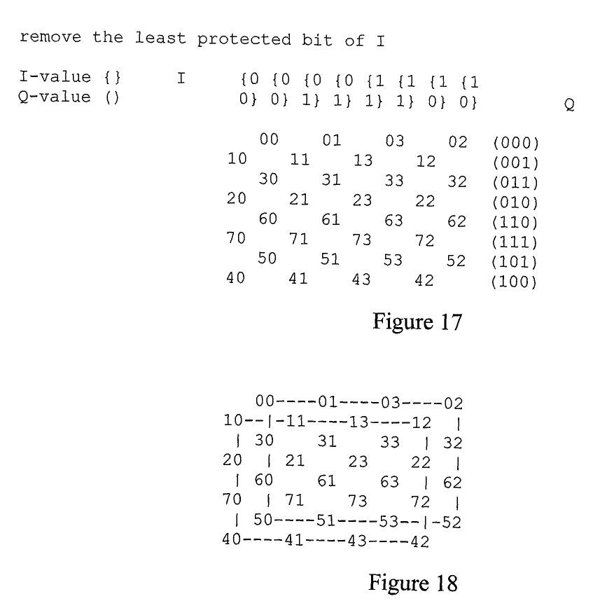

Remove the least bit in I. FIG. 17 shows the region created in this case. The resulting non-square constellation is the superposition of two square constituent constellations, one of which is shifted with respect to the other. This is shown in FIG. 18.

Case 3.4.

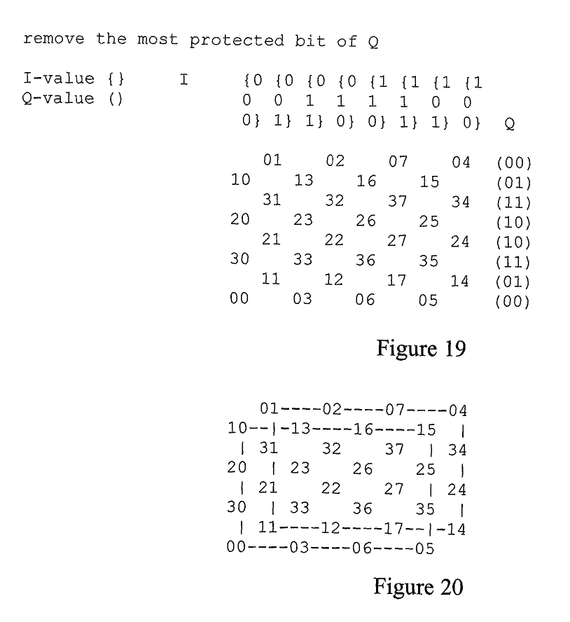

Remove most protected bit in Q. FIG. 19 shows the region created in this case. The resulting non-square constellation is the superposition of two square constituent constellations, one of which is shifted with respect to the other. This is shown in FIG. 20.

Case 3.5.

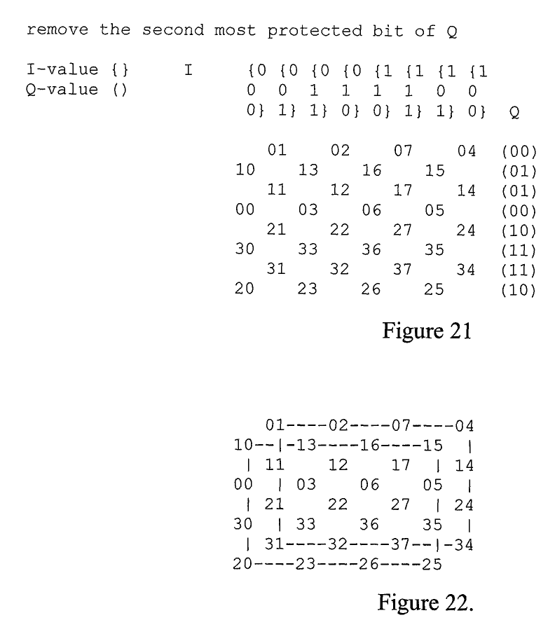

Remove the second most protected bit in Q. FIG. 21 shows the region created in this case. The resulting non-square constellation is the superposition of two square constituent constellations, one of which is shifted with respect to the other. This is shown in FIG. 22.

Case 3.6.

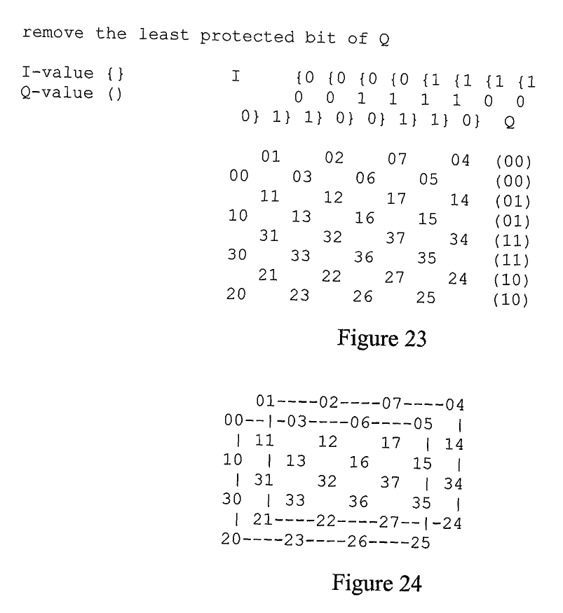

Remove the least protected bit in Q. FIG. 23 shows the region created in this case. The resulting non-square constellation is the superposition of two square constituent constellations, one of which is shifted with respect to the other. This is shown in FIG. 24.

Application to the 128 QAM case.

The following description illustrates possible cases for a 128 QAM constellation with Gray mapping.

Step 1.

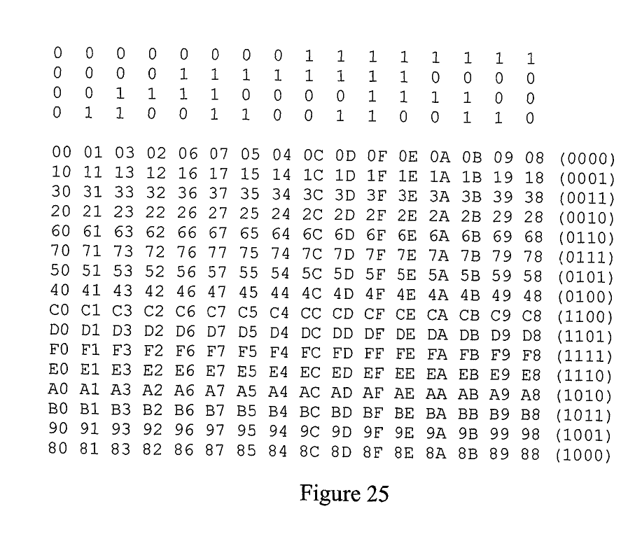

Draw the square constellation that has double the number of points (2ⁿ⁺¹ points) in the desired non-square constellation (2ⁿ points). For 128 QAM, n=7, the square constellation is 256 QAM with independent I and Q Gray mapping or Natural Mapping. FIG. 25 shows the 256 QAM constellation with Gray Mapping. The first number represents the Q dimension and the second number represents the I dimension.

Step 2.

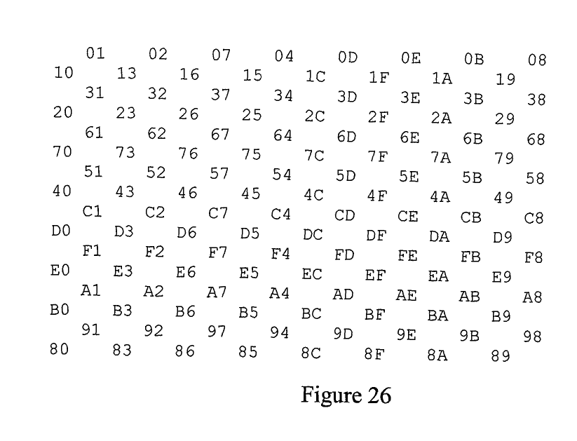

Delete every other point in each dimension such that each row keeps half of its points and every column keeps half of its points, and such that the constellation points that remain have the same distance between them. FIG. 26 shows the constellation after removing half of the points. The technique produces similar constellations if the removed points are kept and the kept points are removed.

Step 3.

Assign to each remaining point a number formed from the bits of the I value and bits of the Q value of the original constellation map, where one bit position of the I value or one bit position of the Q value have been removed. There are 8 manners in which this may be done.

Case 3.1.

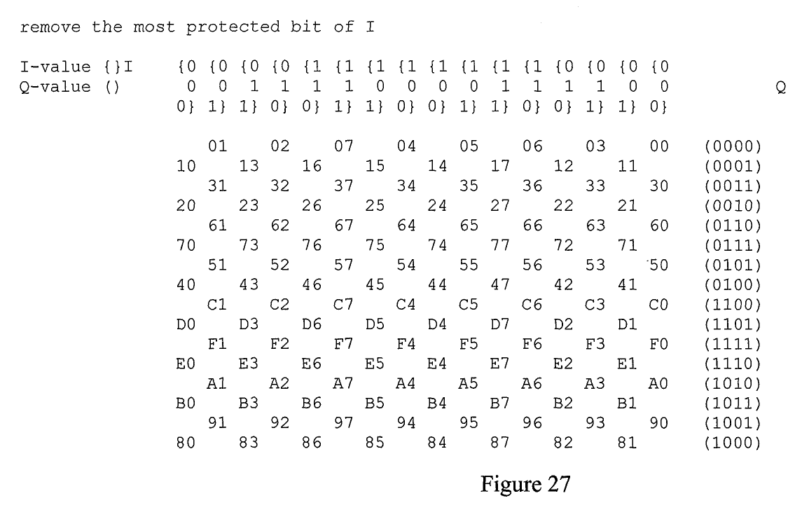

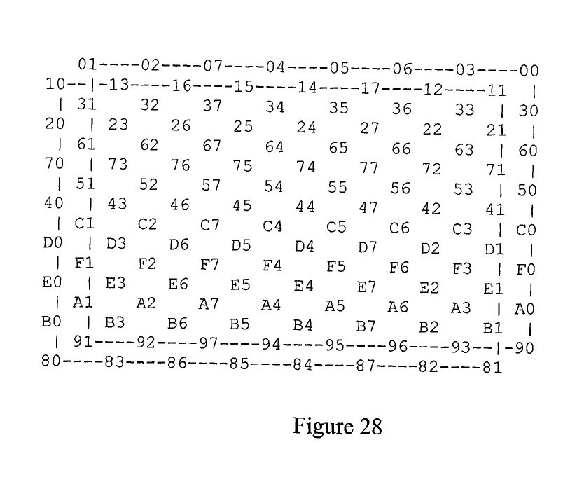

Remove the most protected bit in I. FIG. 27 shows the region created in this case. The resulting non-square constellation is the superposition of two square constituent constellations, one of which is shifted with respect to the other. This is shown in FIG. 28.

Case 3.2.

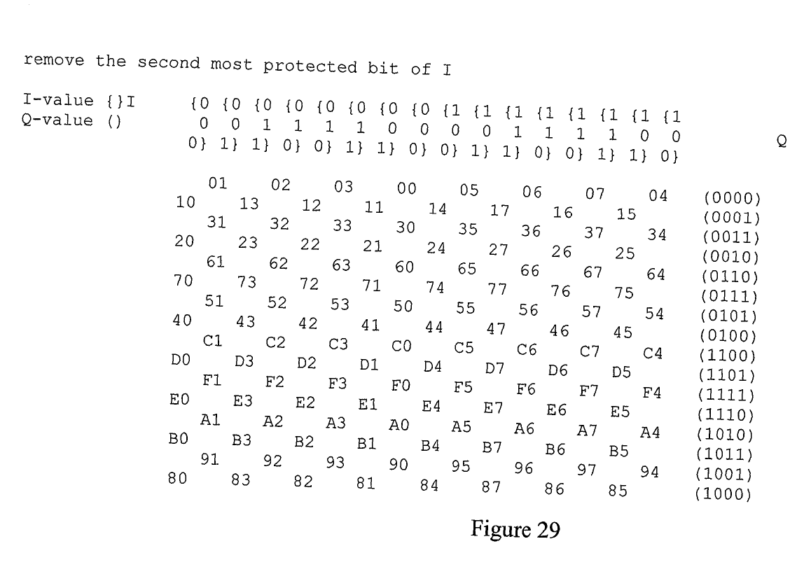

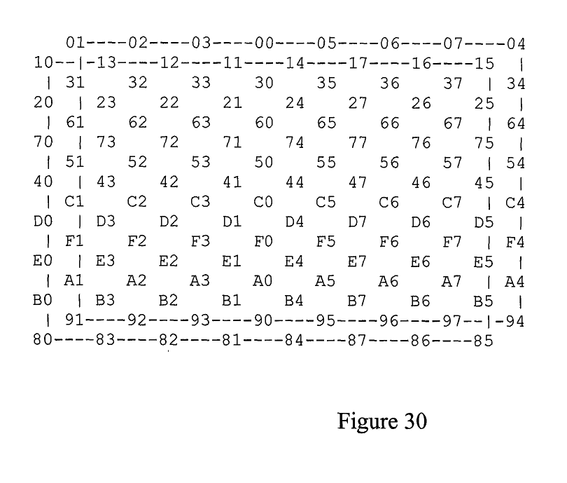

Remove the second most protected bit in I. FIG. 29 shows the region created in this case. The resulting non-square constellation is the superposition of two square constituent constellations, one of which is shifted with respect to the other. This is shown in FIG. 30.

Case 3.3.

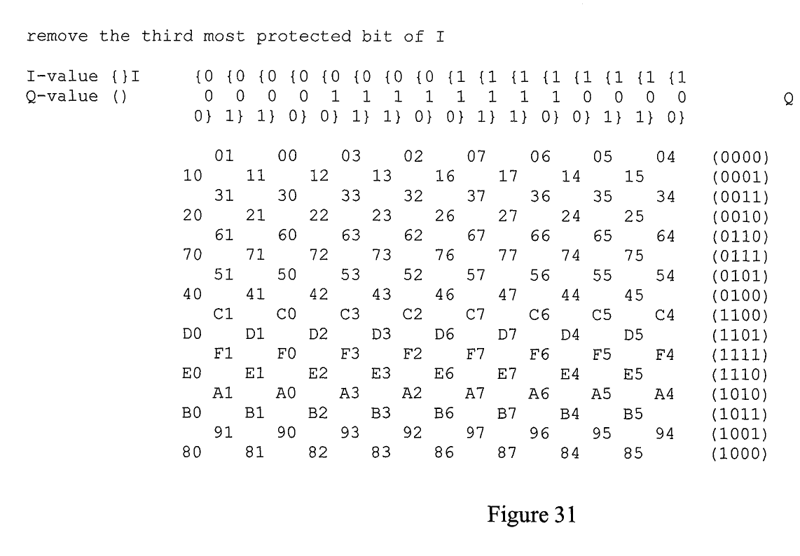

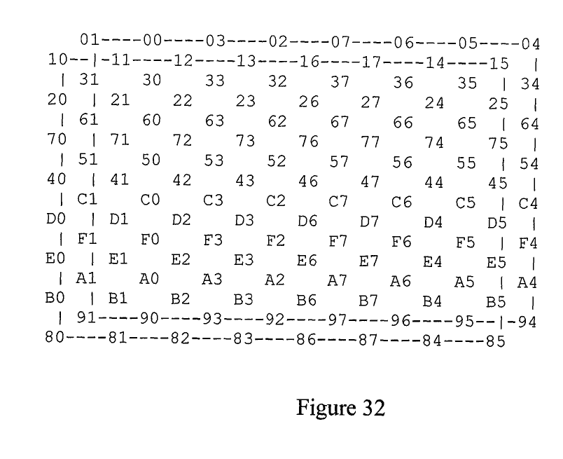

Remove the third most protected bit in I. FIG. 31 shows the region created in this case. The resulting non-square constellation is the superposition of two square constituent constellations, one of which is shifted with respect to the other. This is shown in FIG. 32.

Case 3.4.

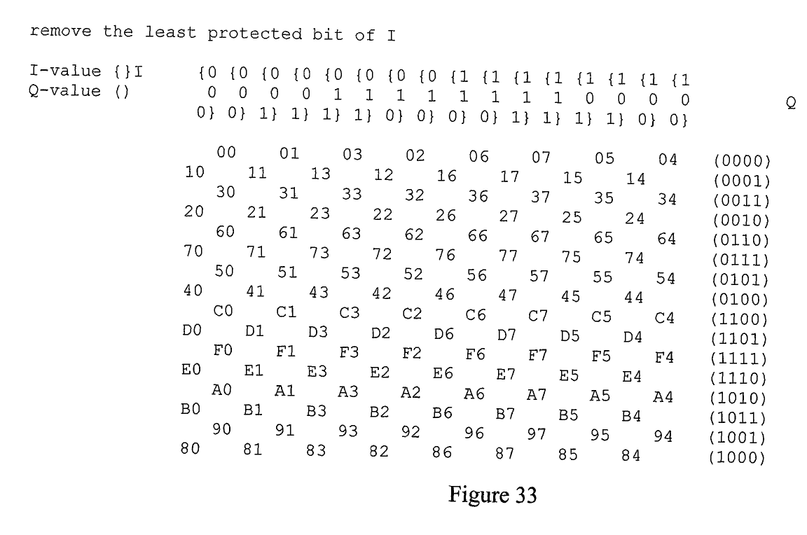

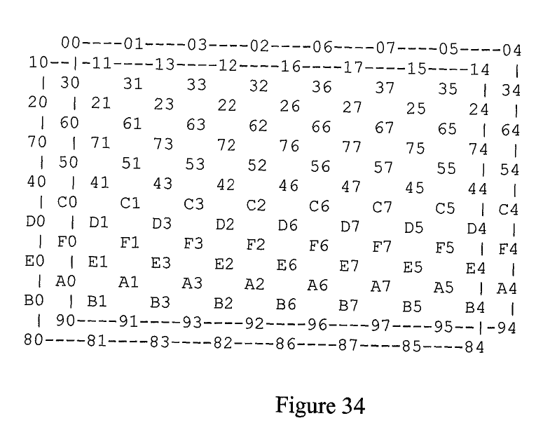

Remove the least protected bit in I. FIG. 33 shows the region created in this case. The resulting non-square constellation is the superposition of two square constituent constellations, one of which is shifted with respect to the other. This is shown in FIG. 34.

Case 3.5.

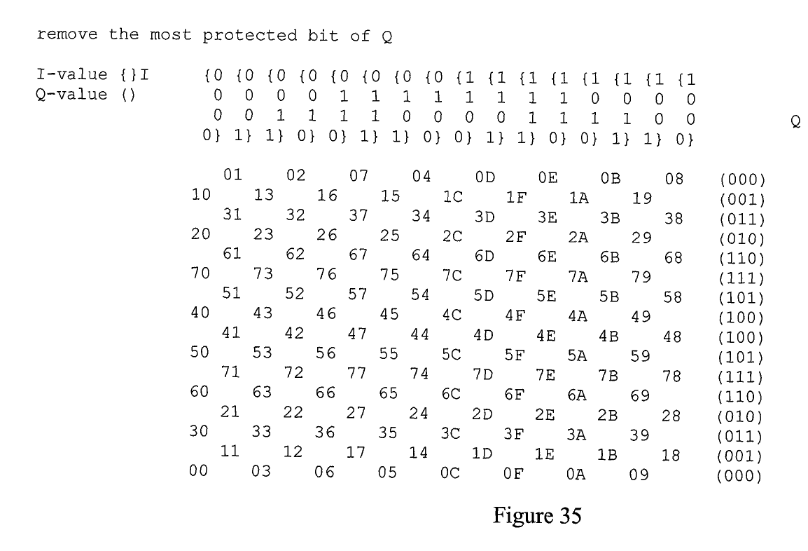

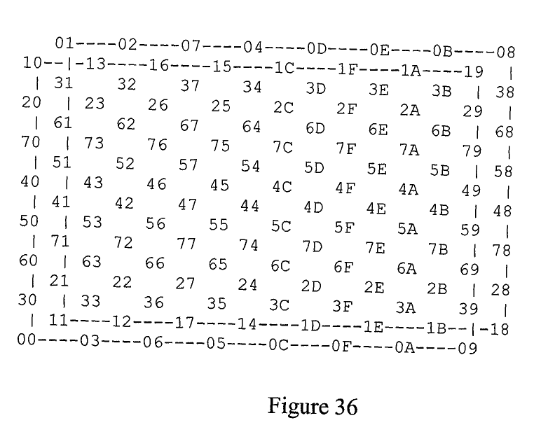

Remove the most protected bit in Q. FIG. 35 shows the region created in this case. The resulting non-square constellation is the superposition of two square constituent constellations, one of which is shifted with respect to the other. This is shown in FIG. 36.

Case 3.6.

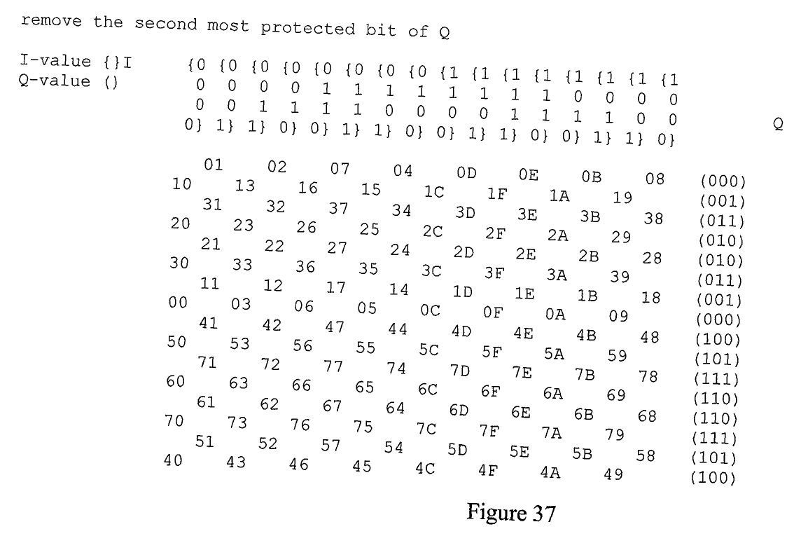

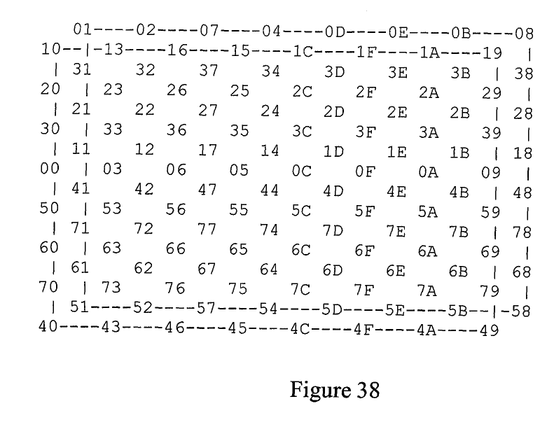

Remove second most protected bit in Q. FIG. 37 shows the region created in this case. The resulting non-square constellation is the superposition of two square constituent constellations, one of which is shifted with respect to the other. This is shown in FIG. 38.

Case 3.7.

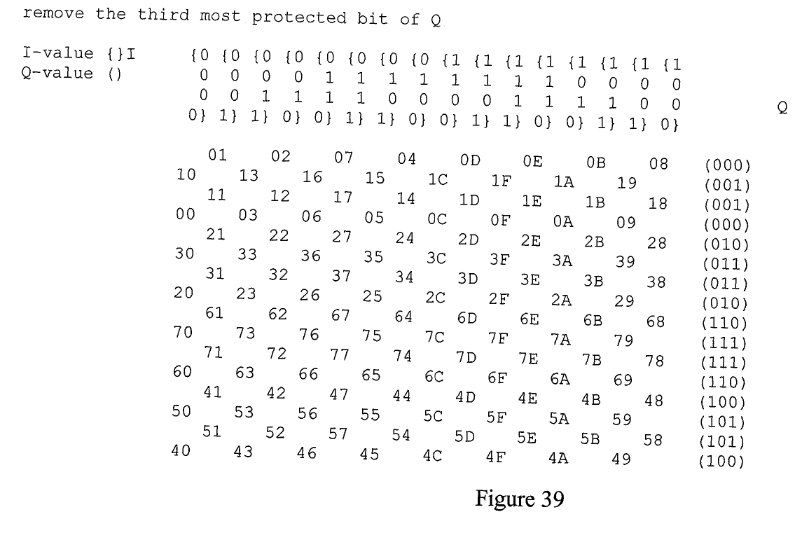

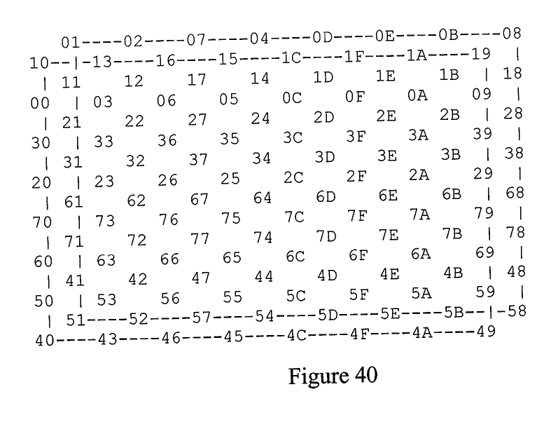

Remove the third most protected bit in Q. FIG. 39 shows the region created in this case. The resulting non-square constellation is the superposition of two square constituent constellations, one of which is shifted with respect to the other. This is shown in FIG. 40.

Case 3.8.

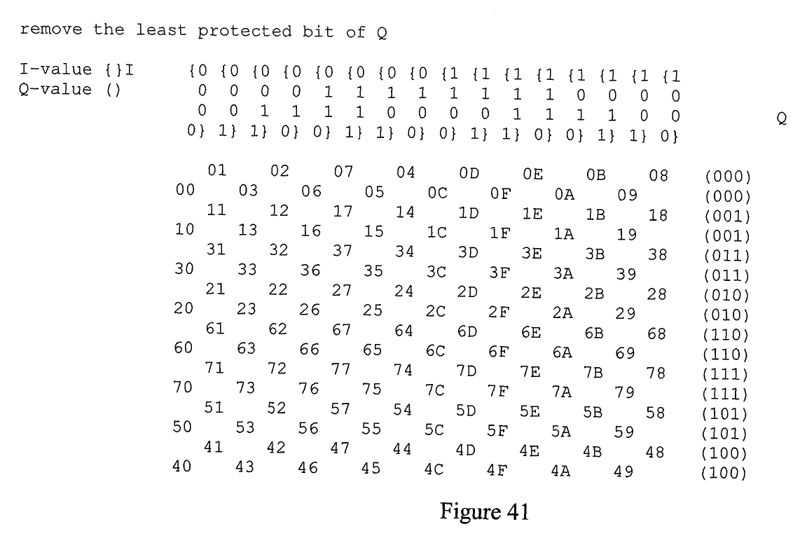

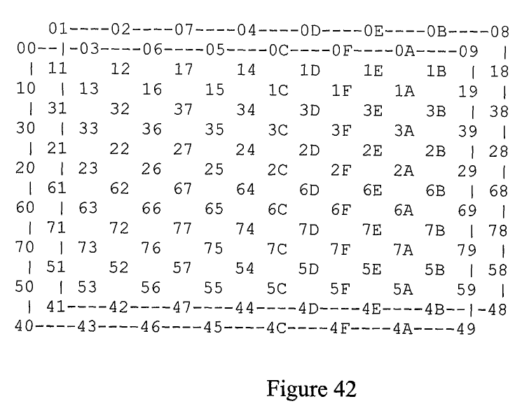

Remove the least protected bit in Q. FIG. 41 shows the region created in this case. The resulting non-square constellation is the superposition of two square constituent constellations, one of which is shifted with respect to the other. This is shown in FIG. 42.

Higher Order Modulations

A similar design process may be followed for cases above 128 QAM.

Constellations with non-square constituents and more than two constituents

While the above examples describe various types of non-square constellations that are composed of the union of two square constituents, in alternative embodiments the constituents may be non-square, for example, rectangular. Further, there may be more than two constituents. In accordance with embodiments of the invention, the constituents need only have independent I and Q.

Impact on Computational Complexity

A normally non-separable constellation that is comprised of separable I and Q constituent constellations may be decoded with approximately the efficiency provided by separable constellations.

For example, a normally non-separable 8 point constellation can be created:

$$\begin{matrix} & ( - 1 , + 3 ) & & ( + 3 , + 3 ) \\ ( - 3 , + 1 ) & & ( + 1 , + 1 ) & \\ & ( - 1 , - 1 ) & & ( + 3 , - 1 ) \\ ( - 3 , - 3 ) & & ( + 1 , - 3 ) & \end{matrix}$$

with the symbols assignments of:

$$\begin{matrix} & 001 & & 010 \\ 100 & & 111 & \\ & 101 & & 110 \\ 000 & & 011 & \end{matrix}$$

and the point assignments of:

$$\begin{matrix} & p31 & & p33 \\ p20 & & p22 & \\ & p11 & & p13 \\ p00 & & p02 & \end{matrix}$$

by combining the following separable constellations:

constellation A, defined as:

$$\begin{matrix}( - 3 , + 1 ) & ( + 1 , + 1 ) \\ ( - 3 , - 3 ) & ( + 1 , - 3 )\end{matrix}$$

with the symbols assignments of:

$$\begin{matrix}100 & 111 \\ 000 & 011\end{matrix}$$

and the point assignments of:

$$\begin{matrix}p20 & & p22 \\ p00 & & p02\end{matrix}$$

constellation B, defined as:

$$\begin{matrix}( - 1 , + 3 ) & & ( + 3 , + 3 ) \\ ( - 1 , - 1 ) & & ( + 3 , - 1 )\end{matrix}$$

with the symbols assignments of:

$$\begin{matrix}001 & & 010 \\ 101 & & 110\end{matrix}$$

and the point assignments of:

$$\begin{matrix}p31 & & p33 \\ p11 & & p13\end{matrix}$$

Again extracting the value for the least significant bit as:

$$value = \frac{S 1}{S 0} = \frac{{\sum }_{bit = 1} {ⅇ}^{( - {n}^{*} {m}_{ij} )}}{{\sum }_{bit = 0} {ⅇ}^{( - {n}^{*} {m}_{ij} )}} \begin{matrix}; ij = 31 , 11 , 22 , 02 \\ ; ij = 20 , 00 , 33 , 13 ,\end{matrix} \qquad ( 23 )$$

$$= \frac{S 1 A + S 1 B}{S 0 A + S 0 B} \qquad ( 24 )$$

where:

S1A=Σe^{(-n*m}^{ᵢⱼ}⁾ ij=22, 02 (25)

S1B=Σe^{(-n*m}^{ᵢⱼ}⁾ ij=31, 11 (26)

S0A=Σe^{(-n*m}^{ᵢⱼ}⁾ ij=20, 00 (27)

S0B=Σe^{(-n*m}^{ᵢⱼ}⁾ ij=33, 13 (28)

Since constellations A and B have separable I and Q,

S1A=SyASx1A (29)

S1B=SyBSx1B (30)

S0A=SyASx0A (31)

S0B=SyBSx0B (32)

Sx1A=Σe^{(-n*mxj)} j=2 (33)

Sx0A=Σe^{(-n*mxj)} j=2 (34)

SyA=Σe^{(-n*myi)} j=2 (35)

Sx1B=Σe^{(-n*mxj)} j=2 (36)

Sx0B=Σe^{(-n*mxj)} j=2 (37)

SyB=Σe^{(-n*myi)} j=2 (38)

and the value extracted from the channel for the least significant bit would be:

$$value = \frac{S 1 A + S 1 B}{S 0 A + S 0 B} = \frac{SyA Sx 1 A + SyB Sx 1 B}{SyA Sx 0 A + SyB Sx 0 B} \qquad ( 39 )$$

Additional reduction of computation can be achieved by recognizing that SyA and SyB are identical for the second least significant bit.

As an example of the complexity reduction, consider a large QAM constellation, say 128 symbols, that was created from two constituent 64 bit constellations. The complexity for both full and reduced calculations are, for all bits:

| | | | | |
|---|---|---|---|---|
| 128 QAM | # exp. | # adds | # mul | # div |
| TOTAL | | | | |
| Full | 32 | 7 * 126 | 121 | 7 |
| 1,042 | | | | |
| Reduced | 32 | 7 * 14 + 2 * 14 | 14 | 14 |
| 186 | | | | |
| N odd | | | | |
| N = 2ⁿ QAM | # exp. | # adds | # mul | # div |
| TOTAL | | | | |
| Full | 2(2N)^{1/2} | n(N − 2) | N − n | n |
| 2(2N)^{1/2} + (n + 1)N − 2n | | | | |
| Reduced | 2(2N)^{1/2} | 2n² + 4n | 2n | 2n |
| 2(2N)^{1/2} + 2n² + 8n | | | | |

The increase in complexity for this type of constellation can be shown to be of O(N)^{½}) where N is the number of constellation points.

Application to Transmitters and Receivers

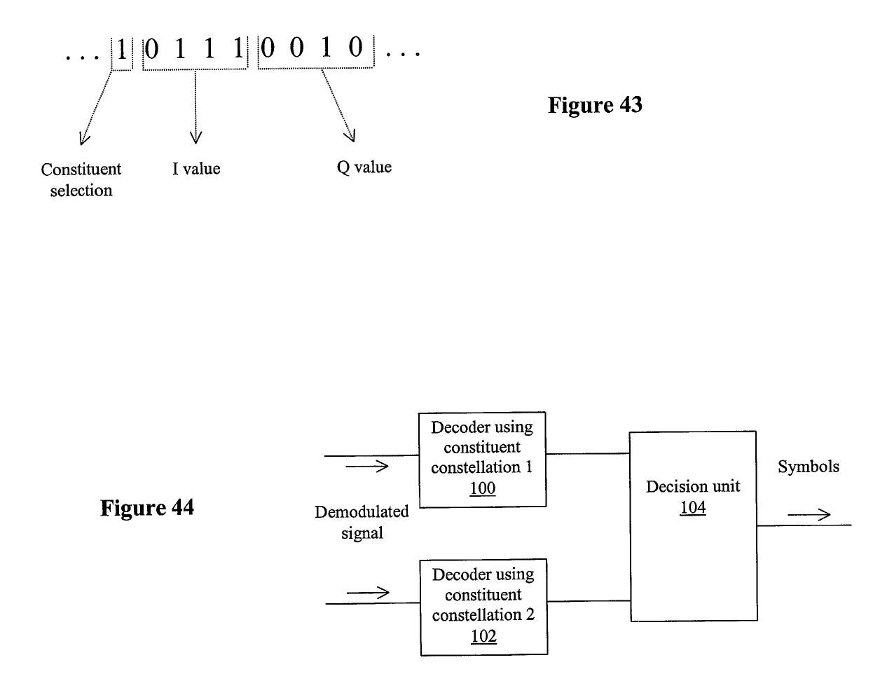

Embodiments of the invention may apply the foregoing schemes in transmitters and receivers of a communication system. FIG. 43 shows an example of mapping of a transmit data stream to transmit symbols in a transmitter in accordance with one embodiment of the invention. As shown in FIG. 43, within a sequence of bits of a transmit data stream, a first group of bits of the data stream is used for selecting a constituent constellation, a second group of bits of the data stream is used for selecting an I value of a symbol within the selected constituent, and a third group of bits is used for selecting a Q value of a symbol within the selected constituent. In the illustrated example, the constellation selection bit group is sequential with the Q value selection bit group, and the Q value selection bit group is sequential with the I value selection bit group. However, in alternative embodiments these groups need not be taken in this order and need not be taken sequentially, and the bits of each group need not be sequential within the bit stream. Nor do they need to consist of separate groups of bits. Rather, any pattern may be used for selecting transmit data bits for use as each group. Therefore, the mapping of transmit data bits to symbols generally comprises selecting constituent constellations and selecting I and Q values within the selected constituent constellations in accordance with the transmit data stream. It is necessary only that the particular manner in which bits of each group are selected is known by a device receiving the resulting symbols so that the data stream from which they were generated can be reconstructed.

FIG. 44 shows an example of a process in a receiver for decoding a modulated signal representing a symbol stream that has been generated in a transmitter as illustrated in FIG. 44. The signal is demodulated and the demodulated signal is applied as input to decoders 100, 102. Each decoder provides decision values for each inputted symbol with respect to each of the symbols of one of the constituent constellations. These decisions may be hard decisions or soft decisions depending on the type of decoder used. The outputs of the decoders 100, 102 are provided to a decision unit 104 that determines the transmitted symbol based on the outputs of the decoders. Because the processing complexity of each decoder is limited to that of a constituent constellation having independent I and Q, the overall non-separable constellation may be decoded with the efficiency of a separable constellation. In the illustrated example, there are two constituent constellations, and therefore two decoders are used. However, in alternative embodiments, a different number of constituent constellations may be employed, and the number of decoders will be chosen accordingly.

In accordance with further embodiments of the invention, processing as described above may be implemented in computing devices comprising at least one processor and storage media storing programming code for performing the processing.

While the embodiments discussed above include a combination of features, those features may characterize further embodiments of the invention individually or in other combinations, and thus it will be apparent to those having ordinary skill in the art that the features and tasks described herein are not necessarily exclusive of other features and tasks, nor required to exist in only those combinations particularly described, but rather that further alternative combinations may be implemented and that additional features and tasks may be incorporated in accordance with particular applications. Thus, while the embodiments illustrated in the figures and described herein are presently preferred, it should be understood that these embodiments are offered by way of example only. The invention is not limited to a particular embodiment, but extends to various modifications, combinations, and permutations that fall within the scope and spirit of the appended claims.

What is claimed is:

1. A method in a transmitter of a communications system, comprising:
mapping a data stream to symbols of a symbol constellation to produce a symbol stream;
modulating a signal in accordance with the symbol stream; and
transmitting the modulated signal,
wherein the symbol constellation comprises a plurality of constituent constellations each having independent I and Q mapping, and
wherein mapping the data stream to symbols of the symbol constellation comprises selecting constituent constellations and selecting I and Q values within the selected constituent constellations in accordance with the data stream.

2. The method claimed in claim 1, wherein said mapping comprises:
selecting a constituent constellation in accordance with a first group of transmit data bits;
selecting an I value in accordance with a second group of transmit data bits; and
selecting a Q value in accordance with a third group of transmit data bits.

3. The method claimed in claim 1, wherein said constituent constellations are square.

4. The method claimed in claim 1, wherein said plurality of constituent constellations consists of two constituent constellations.

5. The method claimed in claim 1, wherein said plurality of constituent constellations consists of two square constituent constellations.

6. The method claimed in claim 1, wherein said plurality of constituent constellations consists of two square constituent constellations of equal size, and
wherein said constituent constellations are offset from one another by one half spacing in the I and Q dimensions within said symbol constellation.

7. A transmitter for a communication system, comprising:
at least one processor; and
storage media coupled to the at least one processor and having stored therein programming instructions for mapping a data stream to symbols of a symbol constellation to produce a symbol stream for transmission,
wherein the symbol constellation comprises a plurality of constituent constellations each having independent I and Q mapping, and
wherein mapping the data stream to symbols of the symbol constellation comprises selecting constituent constellations and selecting I and Q values within the selected constituent constellations in accordance with the data stream.

8. A method in a receiver of a communications system, comprising:
receiving a modulated signal representing a symbol stream generated by mapping a transmit data stream to symbols of a symbol constellation;
demodulating the signal; and
generating a received data stream from the demodulated signal,
wherein the symbol constellation comprises a plurality of constituent constellations each having independent I and Q mapping, and
wherein generating the received data stream comprises:
applying the demodulated signal to a plurality of decoders, each of the decoders providing decoding with respect to one of said constituent constellations; and
determining symbols of the symbol stream from outputs of the decoders.

9. The method claimed in claim 8, wherein said constituent constellations are square.

10. The method claimed in claim 8, wherein said plurality of constituent constellations consists of two constituent constellations.

11. The method claimed in claim 8, wherein said plurality of constituent constellations consists of two square constituent constellations.

12. The method claimed in claim 8, wherein said plurality of constituent constellations consists of two square constituent constellations of equal size, and
wherein said constituent constellations are offset from one another by one half spacing in the I and Q dimensions within said symbol constellation.

13. A receiver for a communication system, comprising:
at least one processor; and
storage media coupled to the at least one processor and having stored therein programming instructions for generating a received data stream from a demodulated signal representing a symbol stream generated by mapping a transmit data stream to symbols of a symbol constellation,
wherein the symbol constellation comprises a plurality of constituent constellations each having independent I and Q mapping, and
wherein generating the received data stream comprises:
applying the demodulated signal to a plurality of decoders, each of the decoders providing decoding with respect to one of said constituent constellations; and
determining symbols of the symbol stream from outputs of the decoders.
